(19) United States
(12) Patent Application Publication
(10) Pub. No.: US 2002/0097717 A1
(43) Pub. Date: Jul. 25, 2002

(54) Microkernel architecture-based forwarder

(76) Inventor: Peter C. Vinsel, Berkeley, CA (US)

Correspondence Address: Andre L. Marais, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/002,440

(22) Filed: Nov. 1, 2001

Related U.S. Application Data
(60) Provisional application No. 60/263,409, filed on Jan. 22, 2001.

(51) Int. Cl. H04L 12/56

(52) U.S. Cl. 370/389; 370/469

(57) ABSTRACT

A method of forwarding data packets in a network device having an operating system. The method includes forwarding a data packet at the device driver layer in the network device without the operating system performing context switching in conjunction with forwarding the data packet. In another embodiment, a method of forwarding data packets in a network device having an operating system includes initiating a switching microdriver to retrieve a data packet, and forwarding the data packet to or from the switching microdriver without involvement of the operating system.

### CROSS REFERENCE TO RELATED APPLICATION

This application claims priority from the provisional application titled MICROKERNEL ARCHITECTURE-BASED FORWARDER, Serial Number 60/263,409, filed on Jan. 22, 2001.

### FIELD OF THE INVENTION

The present invention relates generally to networking devices and, more particularly, to software-based forwarding of data packets in network devices such as concentrators, switches, routers, and the like.

### BACKGROUND

Network devices such as concentrators, routers, switches, and the like are used to forward data from one part of a network to another. Typically, such network devices have multiple ports and include hardware and software that work together to transfer data between one or more ports. With increasing demands for greater bandwidth and faster data transfer rates, new network devices must be designed for higher performance.

Network devices typically include processors and circuitry or software that forward data from an input port to one or more output ports. Typically, the forwarding functions of such network devices are designed into hardware where relatively high packet transfer rates can be achieved. Hardware based forwarders, however, typically have a high cost of development and very low flexibility in terms of being easily upgraded or scalable.

Software-based forwarders based on real-time operating systems are currently used. Typical software-based forwarding systems are built using combinations of device drivers and tasks in a real-time operating system (OS). Such software-based forwarders work with the real-time kernel of the OS. Typically, real-time kernels work to protect each of the tasks or device drivers of the OS from each other by executing functions sequentially, or according to a set of priorities. In a real-time operating system, whenever changes are made to a particular task or device driver, there is the possibility of corrupting the architecture, which leads to potential deadlocks and mutual exclusion problems that the OS is designed to protect against. Therefore, such systems must be designed very carefully and may still have bugs that are difficult to find.

In a typical OS, the real-time kernel schedules the execution of a task based on events. This function of the real-time kernel is commonly referred to as context switching or task switching. With context switching, the OS can switch from one program or task to another without losing its execution location in the first task. In context switching, the central processing unit (CPU) does not switch back and forth between concurrently running programs, but executes only one program at that time. In a network device that transfers packets of data, one example of an event that may trigger context switching is the OS receiving notification from a device driver that there is a packet ready to be transferred. The OS then schedules execution of a task or device driver that performs the functions necessary to retrieve the packet, decide what to do with it, and forward it to an appropriate destination.

For example, a typical sequence of events in a prior art software-based forwarder may occur as follows. A hardware component of the network device indicates that a data packet has been received from a network interface port. The OS network interface device driver initiates processing and retrieves the data packet from the hardware. The network interface device driver then uses a form of an interprocess communication facility of the OS to transfer the packet, or a reference of the packet, to a layer 2 task that will perform further processing of the packet. The network interface device driver then stops. The layer 2 task receives an indication from the OS that there is a packet to be processed in whatever interprocess communication facility that is being used. The layer 2 task then receives the packet, and “decides” what to do with the packet. For example, the layer 2 task may decide to transmit the packet to a network interface port device driver or, in the case of a layer 3 packet, to a layer 3 task. In the case of the packet being transferred to the network interface device driver, the layer 2 task stops its functioning, and the OS initiates the network interface device driver to transmit the packet. The device driver retrieves the packet from the interprocess communication facilities and communicates with the hardware to cause the packet to be transmitted to the physical port. The device driver then stops.

The OS performs context switching at the points where a particular task or device stops and another starts (i.e. the OS turns different functional blocks of software on and off). Each context switch causes a delay in the forwarding of the data packet. In a typical software-based forwarder, the packet traveling from one device driver to another may require the real-time kernel to perform at least two and up to four or more context switches.

Some prior art implementations of software-based forwarders may eliminate context switching between the layer 2 task and the layer 3 task by having the layer 2 task perform the layer 3 task's functions. Also, in some cases, the context switch between the layer 2 task on the transmit side and the network interface device driver can be eliminated by making use of hardware.

It should be noted that not all packets that are received from the physical port will be transmitted through to physical port. For instance, some packets are processed for purposes of management or protocol work.

A typical packet processing rate in a software-based forwarder is approximately 30,000 to 40,000 packets per second. This packet processing rate is typical of a software-based forwarder of a typical design that uses a real-time event driven, priority based OS kernel. A typical context switch can take about two to three microseconds. As packet processing rates increase in modem network devices, the cumulative effect of context switching can be to significantly decrease performance by slowing down the packet processing rate.

### SUMMARY OF THE INVENTION

In one embodiment, the present invention provides a method of forwarding data packets in a network device having an operating system. The method includes forwarding a data packet at the device driver layer in the network device without the operating system performing context switching in conjunction with forwarding the data packet. In another embodiment, a method of forwarding data packets in a network device having an operating system includes initiating a switching microdriver to retrieve a data packet, and forwarding the data packet to or from the switching microdriver without involvement of the operating system.

### BRIEF DESCRIPTION OF THE DRAWINGS

The invention is illustrated by way of example, and not limitation, in the figures of the accompanying drawings in which:

FIG. 1 is a block diagram of an embodiment of the invention; and

FIG. 2 illustrates the flow of actions taken according to an embodiment of the present invention.

### DETAILED DESCRIPTION

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data within a computer memory. These algorithmic descriptions and representations are the means used by those skilled in the data processing arts to most effectively convey the substance of their work to others skilled in the art.

An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated or otherwise apparent from the following discussion throughout the description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention also relates to apparatuses for performing the operations herein. These apparatuses may be specially constructed for the required purposes, or may comprise a general-purpose computer selectively activated or reconfigured by a computer program stored in the computer. Such a computer program may be stored in a machine-readable or accessible storage medium, such as, but not limited to, any type of magnetic or other disk storage media including floppy disks, optical storage media, CD-ROMs, and magnetic-optical disks, read-only memories (ROMs), random access memories (RAMs), EPROMs, EEPROMs, magnetic or optical cards, flash memory devices, electrical, optical, acoustical or other form of propagated signals (e.g., carrier waves, infrared signals, digital signals, etc.); etc. or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

In one embodiment, the present invention provides a method of forwarding data packets in a network device having an operating system (OS). Networking operating systems may include but are not limited to VxWorks™ by Wind River, Nucleus™ by ATI, and IOS™ by Cisco. The method includes forwarding a data packet at the device driver layer in the network device without the operating system performing context switching in conjunction with forwarding the data packet. In another embodiment, a method of forwarding data packets in a network device having an operating system includes initiating a switching microdriver to retrieve a data packet, and forwarding the data packet to or from the switching microdriver without involvement of the operating system.

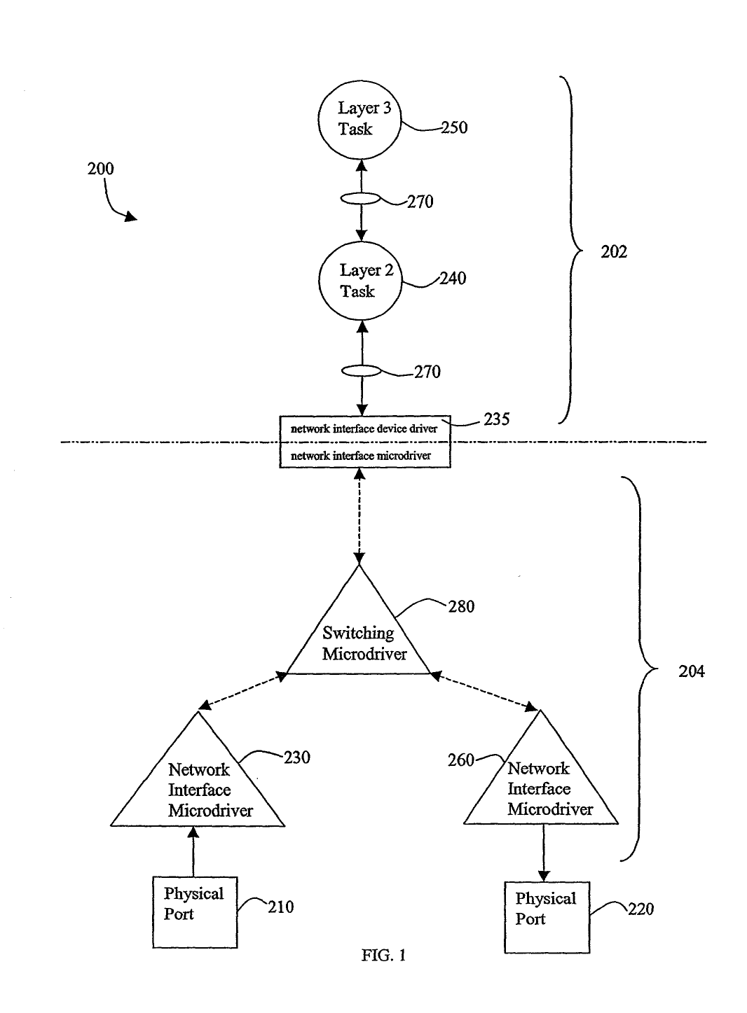

FIG. 1 shows an embodiment of a microkernel architecture-based forwarder 200 in a network device having an operating system. In this embodiment, the data packets are transferred at the device driver layer without the involvement of the operating system. FIG. 1 shows a block diagram that represents processes or operations that are performed to forward data packets.

As shown in FIG. 1, the hardware indicates that a packet has been received from a network interface such as physical port 210. A network interface microdriver 230 is initiated to process the packet. The network interface microdriver 230 retrieves the packet from the hardware and then sends the packet to a switching microdriver 280, which performs switching decisions without using an OS-aware interprocess communication facility. In one embodiment, the switching microdriver 280 makes a layer 2 or a layer 3 decision to transmit the data packet to another network interface microdriver 260, which then transfers the packet to a physical port 220 in the hardware.

Examples of the types of physical ports that may be provided to interface with various embodiments of the invention include, but are not limited to, T1, DSL, OC3, cable modem, serial port, ethernet and the like.

The network interface microdrivers 230 and 260 and the switching microdriver 280 are in the non OS-aware portion 204 of the forwarder 200. Thus, the OS is not involved in the starting and stopping of each of these microdrivers. For instance, the OS does not schedule the switching microdriver 280 to make the layer 2 or layer 3 decisions in the non OS-aware portion 204 of the forwarder 200. The microdrivers in this portion are started and stopped in sequential processing. No context switching is performed at the device driver layer, i.e. the non OS-aware portion 204. Thus, a much higher packet forwarding rate can be achieved. To perform the layer 2 or layer 3 decisions in the non OS-aware portion 204, the network interface microdrivers 230 and 260 and the switching microdriver 280 may need to maintain databases to use in making forwarding decisions.

In one embodiment, the switching microdriver 280 may transfer the data packets into the OS-aware portion 202 of the forwarder 200 in the case of a data packet that is meant for management or protocol work.

For example, addressing information in the data packet may indicate that the receiving task or driver is the destination or that the receiving task or driver is not the destination of the packet, in which case the packet is merely to be forwarded. In this case, the data packet may be transferred through a network interface driver 235 and further through a layer 2 task 240 and possibly a layer 3 task 250. As shown in FIG. 1, the layer 2 and layer 3 tasks are in the OS-aware portion 202 of the forwarder 200, and therefore the OS will perform context switching 270 between starting and stopping of each of the layer 2 and layer 3 tasks.

The network interface driver 235 may be seen in dual mode. On the OS-aware portion 202, the network interface driver 235 may be seen as a network interface device driver. On the non-OS aware portion 204, the network interface driver 235 may be seen as a network interface microdriver.

The interface between the OS-aware portion 202 and the non OS-aware portion 204 of the forwarder 200 is preferably minimal. The embodiments of the forwarder 200 have very complex implementations because there are two functional blocks in which layer 2 or layer 3 decisions can be made. These functional blocks making such decisions must keep consistent databases, which increases memory use. Also, a mechanism must be provided to keep the databases consistent when one of the databases is changed. Preferred embodiments of a forwarder 200 of the present invention includes a mechanism that insures that every time a change is attempted to be made to one of the databases at either the OS-aware portion 202 or the non OS-aware portion 204, the change is made to the databases at both portions.

One example of such a mechanism uses an application programming interface (API). When a configuration task, for example, is run that attempts to make a change to a database, the task goes through the API, which performs operations or functions to make the changes to all databases that must be kept consistent. An API includes a group of functions at the point of interface between the OS-aware portion 202 and the non OS-aware portion 204. For example, the API may include groups of functions for transmitting packets, sending packets to another task, or receiving packets.

Since all forwarding decisions in the embodiment of the forwarder 200 shown in FIG. 1 are performed in the non OS-aware portion 204 of the forwarder 200, i.e. without the involvement of the OS, an improved uniformity of performance can be achieved. Also, in one embodiment, the processing of the packets at the non OS-aware portion 204 does not stop for administration functions such as transferring the packet for management or protocol work. The rate of forwarding of the data packets is not decreased in favor of administration functions.

An embodiment of a forwarder 200 such as that shown in FIG. 1, can achieve a packet transfer rate of approximately 80,000 to 85,000 packets per second. A microkernel based forwarder can provide flexibility in choices of hardware, such as type or speed of processor because the forwarding functions are implemented more efficiently in software in the various embodiments of the present invention. For example, as future generations of a network devices such as, but not limited to, a concentrator, are developed, the concentrator may be provided with a higher number of ports or a fiber-optic WAN connection, in which cases much higher data packet rates are required. Embodiments of a microkernel based forwarder make it unnecessary to redesign the processing core to accomplish the higher data packet forwarding rate.

One example of a network device is a concentrator of network access ports that interfaces with high and low speed ports. Such a concentrator can include facilities for a Local Area Network (LAN) port such as a 100 megabit per second (Mbps) Ethernet interface or other types of Wide Area Network (WAN) interfaces depending on the particular application. The line side of the concentrator can include 12 or more virtual DSL (VDSL) ports running at 15 Mbps symmetric data speed, for example. Thus, the total amount of data that is transferred through the concentrator is at least 200 Mbps for each direction, plus 360 Mbps (15 Mbps on each of 12 VDSL ports in two directions), which equals a 560 Mbps total transfer rate. The forwarder 200 on such a device must support a very high packet rate. The packet rate depends on the packet size, such as a packet size of 64 bytes. This is beyond the capabilities of current computer processing.

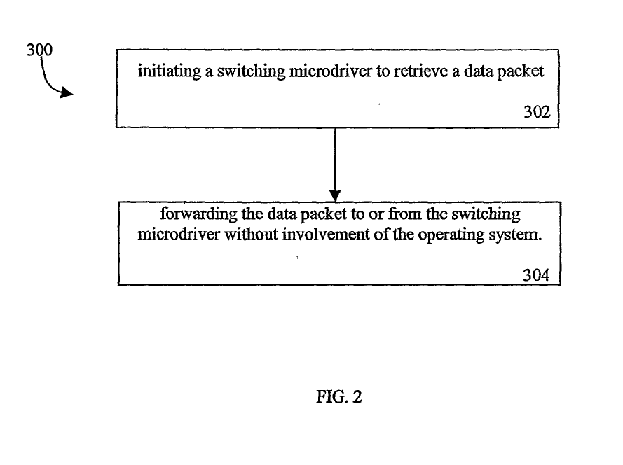

FIG. 2 shows a flowchart of an exemplary embodiment of a method of the present invention in which the various blocks represent operations or procedures to perform the methods. It should be noted that the operations or procedures represented in the flowchart do not necessarily need to be executed in the order shown. Also, all of the operations or procedures may not be necessary for every embodiment of the present invention.

Describing the methods by reference to a flowchart enables one skilled in the art to develop such programs including such instructions to carry out the methods on suitably configured computers (the processor of the computer executing the instructions from computer-readable media). If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or a produce a result.

Method 300 includes the operations shown in blocks 302 through 304. Block 302 shows the process or operation of initiating a switching microdriver to retrieve the data packet. Block 304 shows the process or operation of forwarding the data packet to or from the switching microdriver without involvement of the operating system. As discussed above with reference to FIG. 1, the microdrivers are on the non OS-aware portion 204 of the forwarder 200, and therefore context switching is not performed by the OS in conjunction with forwarding the data packet to or from the switching microdriver or at the initiation or stopping of each microdriver.

In one embodiment, the method can further include performing switching functions by the switching microdriver to forward the data packet. Performing switching functions by the switching microdriver to forward the data packet may include making a layer 2 or a layer 3 switching decision in the switching microdriver. In one embodiment, the switching microdriver may forward the data packet to a network interface microdriver. Also, the switching microdriver may receive or retrieve the packet from a network interface microdriver.

Although an exemplary embodiment of the invention has been shown and described in the form of a software-based forwarder, many changes, modifications, and substitutions may be made without departing from the spirit and scope of this invention.

What is claimed is:

1. A method of forwarding data packets in a network device having an operating system, the method comprising:
initiating a switching microdriver to retrieve a data packet; and
forwarding the data packet to or from the switching microdriver without involvement of the operating system.

2. The method of claim 1 further comprising performing switching functions by the switching microdriver to forward the data packet.

3. The method of claim 2 wherein performing switching functions by the switching microdriver to forward the data packet includes making any one of a layer 2 and a layer 3 switching decision in the switching microdriver.

4. The method of claim 3 further comprising forwarding the data packet to a network interface microdriver.

5. The method of claim 1 wherein no context switching is performed by the operating system in conjunction with forwarding the data packet to or from the switching microdriver.

6. The method of claim 4 further comprising forwarding the data packet to a network interface microdriver.

7. The method of claim 1 wherein no context switching is performed by the operating system in conjunction with forwarding the data packet to or from the switching microdriver, the method further comprising performing switching functions by the switching microdriver to forward the data packet.

8. The method of claim 1 wherein forwarding the data packet to or from the switching microdriver includes receiving the data packet from a network interface microdriver.

9. The method of claim 1 wherein the switching microdriver may perform the functions of a network interface driver for the operating system and may perform the functions of a network interface microdriver without involvement of the operating system.

10. A method of forwarding data packets in a network device having an operating system, the method comprising:
indicating that a data packet has been received by a component of the network device from a network interface port;
initiating a first network interface microdriver to process the data packet;
receiving the data packet at the first network interface microdriver from the component of the network device; and
sending the data packet from the first network interface microdriver to a switching microdriver without involvement of the operating system.

11. The method of claim 10 further comprising forwarding the data packet from the switching microdriver to a selected location without involvement of the operating system.

12. The method of claim 11 wherein involvement of the operating system comprises the operating system performing a context switch.

13. The method of claim 11 wherein involvement of the operating system comprises the operating system initiating an interprocess communication facility.

14. The method of claim 11 wherein the selected location is a second network interface microdriver.

15. The method of claim 11 wherein forwarding the data packet from the switching microdriver to a selected location without involvement of the operating system includes making any one of a layer 2 and a layer 3 switching decision in the switching microdriver.

16. The method of claim 11 wherein the switching microdriver may perform the functions of a network interface driver for the operating system and may perform the functions of a network interface microdriver without involvement of the operating system.

17. A method of forwarding data packets in a network device having an operating system, the method comprising:
forwarding a data packet at the device driver layer in the network device, without the operating system performing context switching in conjunction with forwarding the data packet.

18. The method of claim 17 further comprising:
indicating that the data packet has been received by a component of the network device from a network interface port;
initiating a first network interface microdriver to process the data packet;
receiving the data packet at the first network interface microdriver from the component of the network device; and
sending the data packet from the first network interface microdriver to a switching microdriver.

19. The method of claim 18 further comprising forwarding the data packet from the switching microdriver to a selected location.

20. The method of claim 19 wherein the selected location is a second network interface microdriver.

21. The method of claim 19 wherein forwarding the data packet from the switching microdriver to a selected location includes making any one of a layer 2 and a layer 3 switching decision in the switching microdriver.

22. A machine-readable medium that provides instructions, which when executed by a processor, cause said processor to perform operations comprising:
initiating a switching microdriver to retrieve a data packet; and
forwarding the data packet to or from the switching microdriver without involvement of the operating system.

23. The machine-readable medium of claim 22 wherein said instructions cause said processor to perform operations further comprising switching functions by the switching microdriver to forward the data packet.

24. The machine readable medium of claim 23 wherein performing switching functions by the switching microdriver to forward the data packet includes making any one of a layer 2 and a layer 3 switching decision in the switching microdriver.

25. The machine-readable medium of claim 24 wherein said instructions cause said processor to perform operations further comprising forwarding the data packet to a network interface microdriver.

26. The machine-readable medium of claim 22 wherein no context switching is performed by the operating system in conjunction with forwarding the data packet to or from the switching microdriver.

27. The machine-readable medium of claim 25 wherein said instructions cause said processor to perform operations further comprising forwarding the data packet to a network interface microdriver.

28. The machine-readable medium of claim 22 wherein no context switching is performed by the operating system in conjunction with forwarding the data packet to or from the switching microdriver, said processor further performs switching functions by the switching microdriver to forward the data packet.

29. The machine-readable medium of claim 22 wherein forwarding the data packet to or from the switching microdriver includes receiving the data packet from a network interface microdriver.

30. The machine-readable medium of claim 22 wherein the switching microdriver in a first instance performs the functions of a network interface driver for the operating system and in a second instance performs the functions of a network interface microdriver without involvement of the operating system.

31. A system comprising:
an interprocess communication facility comprising an operating system aware portion and a non-operating system aware portion;
a switching microdriver coupled to said interprocess communication facility to perform switching decisions without using an operating system aware portion of said interprocess communication facility;
a network microdriver coupled to said switching microdriver; and
a physical port coupled to said network microdriver.

32. The system of claim 31 wherein said switching microdriver retrieves a data packet and forwards said data packet to or from said switching microdriver without involvement of said operating system.

33. The system of claim 32 wherein said switching microdriver performs switching functions to forward the data packet.

34. The system of claim 33 wherein said switching microdriver performs switching functions to forward said data packet including making any one of a layer 2 and a layer 3 switching decision in said switching microdriver.

35. The system of claim 32 wherein no context switching is performed by said operating system in conjunction with forwarding said data packet to or from said switching microdriver.

36. The system of claim 32 wherein no context switching is performed by said operating system in conjunction with forwarding said data packet to or from said switching microdriver and said switching microdriver performs switching functions to forward the data packet.

37. The system of claim 34 wherein said switching microdriver forwards said data packet to said network interface microdriver.

38. The system of claim 35 wherein said switching microdriver forwards the data packet to said network interface microdriver

39. The system of claim 32 wherein forwarding the data packet to or from the switching microdriver includes receiving the data packet from a network interface microdriver.

40. The system of claim 32 wherein said switching microdriver in a first instance performs the functions of a network interface driver for the operating system and in a second instance performs the functions of a network interface microdriver without involvement of the operating system.
